(19) United States
(12) Patent Application Publication
(10) Pub. No.: US 2005/0206596 A1
(43) Pub. Date: Sep. 22, 2005

(54) Method for driving a liquid crystal display

(76) Inventors: Benson Chen, Dounan Township (TW); Chih-Hsin Hsu, Hsinchu City (TW)

Correspondence Address: J C PATENTS, INC., 4 VENTURE, SUITE 250, IRVINE, CA, 92618, US

(21) Appl. No.: 10/983,139

(22) Filed: Nov. 4, 2004

(30) Foreign Application Priority Data
Mar. 18, 2004 (TW) 93107216

(51) Int. Cl. G09G 3/36

(52) U.S. Cl. 345/87

(57) ABSTRACT

A method for driving a liquid crystal display is provided. The liquid crystal display includes a plurality of data lines, and each the data line corresponds to a plurality of pixels. In the method, a plurality of specific polarity distributions is used to drive the pixels of each of the data line. A first frame has a first specific polarity distribution, and a successive second frame after the first frame has a second specific polarity distribution. A third frame after the second frame has a third specific polarity distribution, and a fourth frame after the third frame has a fourth specific polarity distribution. It is noted that the first, the second, the third and the fourth specific polarity distributions are different from each other.

### CROSS-REFERENCE TO RELATED APPLICATION

This application claims the priority benefit of Taiwan application serial no. 93107216, filed on Mar. 18, 2004.

### BACKGROUND OF THE INVENTION

1. Field of the Invention

The invention generally relates to a liquid crystal display (LCD). More particularly, the invention relates to a method of polarity inversion of the LCD.

2. Description of Related Art

Recently, because the LCD display panel has the advantages of light weight, compact size, low working voltage, low power consumption and radiation free, it is the main stream of the display. Especially for the portable electronic devices such as the displays of notebook, mobile phone, and personal digital assistant (PDA), the LCD is the only display panel that can satisfy the portability requirement. Hence, the LCD has become indispensable display device and is being further well developed in recent years.

In the LCD display device, if the voltage with a specific polarity is applied to the liquid crystal molecule for a long time, even after that voltage is removed, the liquid crystal molecule would never rotate along with the change of the electric field because the characteristics of the liquid crystal molecule has been permanently damaged. Hence, the polarity of the voltage applied to the LCD has to be inverted in every specific period of time to prevent the permanent damage of the liquid crystal molecule even though the displayed image is not changed. Hence, in the method for driving the LCD, the method for polarity inversion is very important.

The conventional method of polarity inversion for driving the LCD will be described in the following. The voltage applied to the two terminals of the liquid crystal molecule is generally classified into the positive voltage and the negative voltage. FIG. 1A to FIG. 1D illustrate the conventional methods for polarity inversion of the LCD. Generally, the method for polarity inversion of the LCD includes the frame inversion method shown in FIG. 1A, the row inversion method shown in FIG. 1B, the column inversion method shown in FIG. 1C, and the dot inversion method shown in FIG. 1D. The difference between the above inversion methods depends on whether the polarities between two adjacent pixels are the same. The polarity inversion of each pixel is synchronized with the scanning of the entire frame of image. In the frame inversion method, the polarities of all pixels in the same frame are the same, and the polarities of all pixels between two continuous scanning of frame are opposite. In general, flicker will be generated in the image displayed by the frame inversion method due to the polarities of the pixels of the frame are changed at the same time. In addition, cross-talk will be generated in the image displayed by the frame inversion method since the polarities of the adjacent pixels are the same. In the row inversion method, the polarities of pixels between two adjacent rows are opposite. In the column inversion method, the polarities of pixels between two adjacent columns are opposite, and the column inversion method consume lowest power. In the dot inversion method, the polarities between two adjacent pixels are opposite. Because the generation of flicker and cross-talk are obviously improved by the dot inversion method, the method has been widely used recently.

Hence, to take advantage of the less flicker and cross-talk of the dot inversion and to reduce the power consumption, the one-line inversion, the two-line inversion, and the N-line inversion methods are derived from the conventional dot inversion method. FIG. 2A and FIG. 2B illustrate the polarity distribution and the scanning waveform of the conventional one-line inversion method. FIG. 3A and FIG. 3B illustrate the polarity distribution and the scanning waveform of the conventional two-line inversion method. The polarity distribution and the scanning waveform of the conventional N-line inversion method can also be easily derived. Referring to FIG. 3B, for the two-line inversion method, in comparison with the first scan (horizontal) line and the second scan line, it is noted that that the charges of the pixels (proportional to the area of the waveform of the data line) in the even number lines are larger than the charges of the pixels in the odd number lines. Hence, for the user, it is noted that the brightness of the even number lines is higher than that of the odd number lines, i.e., if one line is brighter, the adjacent line is darker. The problem would occur in the two-line inversion and the N-line inversion methods except for the one-line inversion method. Hence, for a LCD display device, it is highly desirable to have a driving circuit and method without flicker, cross-talk, and alternate brightness distribution.

### SUMMARY OF THE INVENTION

Accordingly, the present invention is directed to a method for polarity inversion of the LCD to reduce the power consumption of the LCD.

In addition, the present invention is directed to a method for polarity inversion of the LCD to reduce the alternate brightness of the LCD.

The method of driving a liquid crystal display of the present invention is suitable for a liquid crystal display having a plurality of data lines, wherein each of the data line corresponds to a plurality of pixels. The method comprises, for example but not limited to the following steps. First, a plurality of specific polarity distributions is used to drive the pixels of each of the data line. A first frame has a first specific polarity distribution, and a successive second frame after the first frame has a second specific polarity distribution. A third frame after the second frame has a third specific polarity distribution, and a fourth frame after the third frame has a fourth specific polarity distribution. It is noted that the first, the second, the third and the fourth specific polarity distributions are different from each other.

In one embodiment of the invention, each of the specific polarity distribution has four specific polarities, two of the four specific polarities have a first polarity, and the other two of the four specific polarities have a second polarity.

In one embodiment of the invention, the first, the second, the third, and the fourth specific polarity distributions are arranged by a polarity circulation rule so that the first, the second, the third, and the fourth specific polarity distributions are different from each other.

In one embodiment of the invention, in the polarity circulation rule, a successive specific polarity distribution is constructed by shifting a forefront specific polarity of the specific polarities of a prior specific polarity distribution to the last and the other specific polarities are remained the same.

In one embodiment of the invention, in the polarity circulation rule, a successive specific polarity distribution is constructed by shifting a last specific polarity of the specific polarities of a prior specific polarity distribution to the forefront and the other specific polarities are remained the same.

In one embodiment of the invention, in each of the four specific polarities, the two of the four specific polarities having the first polarity are adjacent to each other, and/or the other two of the four specific polarities having a second polarity are adjacent to each other.

In addition, the present provides a method of driving a liquid crystal display, wherein the liquid crystal display has a plurality of data lines, each the data line corresponds to a plurality of pixels, and each of the pixels has a capacitor. The method comprises, for example but not limited to, the following steps. First, a plurality of specific charge distributions is used to drive the pixels of each of the data lines. A first frame has a first specific charge distribution, and a successive frame after the first frame has a second specific charge distribution. A third frame after the second frame has a third specific charge distribution, and a fourth frame after the third frame has a fourth specific charge distribution. It is noted that the first, the second, the third, and the fourth specific charge distributions are different from each other.

In one embodiment of the invention, each of the first, the second, the third, and the fourth specific charge distributions comprises four specific charging states comprising a charging state, a positively charged state, a discharging state and a negatively charged state.

In one embodiment of the invention, the first, the second, the third, and the fourth specific charge distributions are arrange by a charging state circulation rule so that the first, the second, the third, and the fourth specific charge distributions are different from each other.

In one embodiment of the invention, in the charging state cycle, a successive specific charge distribution is constructed by shifting a forefront specific charging state of a prior specific charge distribution to the last and the other specific charging state remain the same.

In one embodiment of the invention, in the charging state cycle, a successive specific charge distribution is constructed by shifting a last specific charging state of a prior specific charge distribution to the forefront and the other specific charging state remain the same.

Moreover, the present invention provides a method of driving a liquid crystal display, wherein liquid crystal display has a plurality of data lines, each of the data line corresponds to a plurality of pixels. The method comprises, for example but not limited to, the following steps. First, a plurality of specific polarity distributions is used to drive the pixels of each of the data line. A first frame has a first specific polarity distribution, a successive second frame after the first frame has a second specific polarity distribution and so forth. Thus, from the first frame to a 2n^{th} (n>2) frame has the first specific polarity distribution and a 2n specific polarity distribution respectively, wherein from the first to the 2n^{th} specific polarity distributions are different from each other.

In one embodiment of the invention, each of the 2n specific polarity distributions has 2n specific polarities, n of the 2n specific polarities have a first polarity, and the other n of the 2n specific polarities have a second polarity.

In one embodiment of the invention, the first, the second, the third, and the fourth specific polarity distributions are arranged by a polarity circulation rule so that the first, the second, the third, and the fourth specific polarity distributions are different from each other.

In one embodiment of the invention, in the polarity circulation rule, a successive specific polarity distribution is constructed by shifting a forefront specific polarity of the specific polarities of a prior specific polarity distribution to the last and the other specific polarities remain the same.

In one embodiment of the invention, in the polarity circulation rule, a successive specific polarity distribution is constructed by shifting a last specific polarity of the specific polarities of a prior specific polarity distribution to the forefront and the other specific polarities remain the same.

In one embodiment of the invention, in each of the 2n specific polarities, the n of the four specific polarities having the first polarity is adjacent, and/or the other n of the four specific polarities having a second polarity are adjacent to each other.

Furthermore, the present invention provides a method of driving a liquid crystal display, wherein the liquid crystal display has a plurality of data lines, each the data line corresponds to a plurality of pixels, and each of the pixels has a capacitor. The method comprises, for example but not limited to, the following steps. First, a plurality of specific charge distributions is used to drive the pixels of each of the data lines. A first frame has a first specific charge distribution, a successive frame after the first frame has a second specific charge distribution and so forth. Thus, from the first fame to a 2n^{th} frame has the first specific charge distribution and a 2n^{th} specific charge distribution, wherein from the first to the 2n^{th} specific charge distributions are different from each other.

In one embodiment of the invention, each of the first to the 2n^{th} specific charge distributions comprises 2n specific charging states comprising a charging state, n−1 positively charged state, a discharging state and n−1 negatively charged states.

In one embodiment of the invention, each of the first to the 2n^{th} specific charge distributions are arrange by a charging state circulation rule so that the first to the 2n^{th} specific charge distributions are different from each other.

In one embodiment of the invention, in the polarity circulation rule, a successive specific polarity distribution is constructed by shifting a forefront specific polarity of the specific polarities of a prior specific polarity distribution to the last and the other specific polarities remain the same.

In one embodiment of the invention, in the charging state cycle, a successive specific charge distribution is constructed by shifting a last specific charging state of a prior specific charge distribution to the forefront and the other specific charging state remain the same.

In one embodiment of the invention, in each of the first to the 2n^{th} specific charge distributions, the n−1 positively charged status is adjacent, and/or the n−1 negatively charged status is adjacent.

Accordingly, in the method of polarity inversion of the LCD of the present invention, the interval between charging the capacitor and discharging the capacitor is larger than that of the conventional dot inversion method. Therefore, in the present invention, a higher brightness is obtained by applying a lower current compared to the conventional method. Thus the power consumption is reduced. In addition, after every four, six or more consecutive frames, it is observed by the user that any pixel of the frame has the same average brightness due to the persistence of vision. Especially, when the entire frame has the same color, has some fixed images displayed repeatedly, or has a fixed image (e.g., the background image), the present invention can effectively reduce the problem of alternate brightness.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The following drawings illustrate embodiments of the invention and, together with the description, serve to explain the principles of the invention.

FIGS. 1A-1D illustrate the conventional methods for polarity inversion of the LCD.

FIGS. 2A and 2B illustrate a polarity distribution and a scanning waveform of the conventional one-line inversion method.

FIGS. 3A and 3B illustrate a polarity distribution and a scanning waveform of the conventional two-line inversion method.

FIGS. 4A and 4B illustrate a polarity distribution and a scanning waveform of the two-line inversion method in accordance with one embodiment of the present invention.

FIG. 5 illustrates a polarity distribution of the two-line inversion method in accordance with another embodiment of the present invention.

FIGS. 6A and 6B illustrate a polarity distribution of a three-line inversion method in accordance with one embodiment of the present invention.

FIGS. 7A and 7B illustrate a polarity distribution of a three-line inversion method in accordance with one embodiment of the present invention.

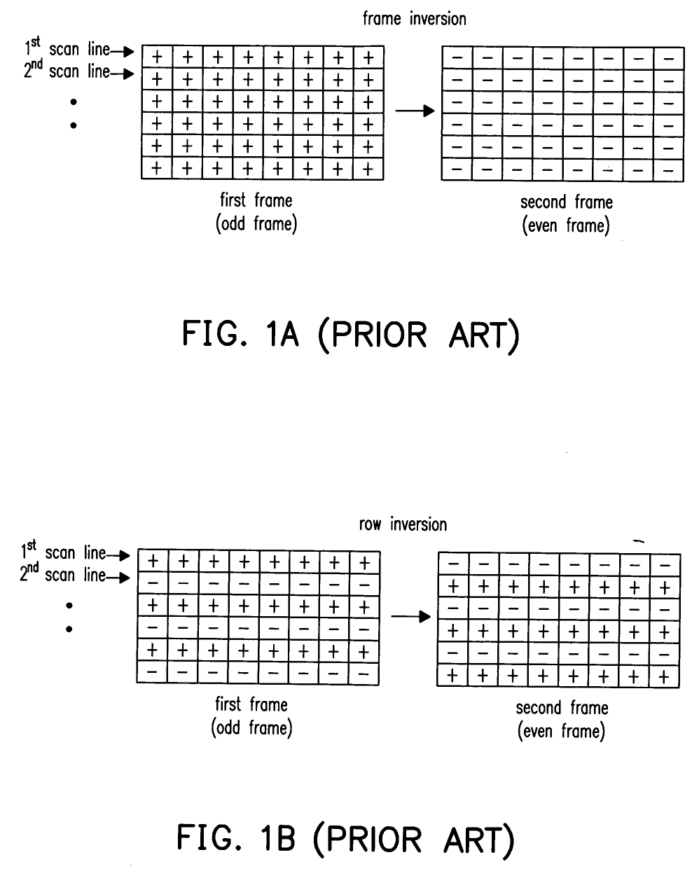

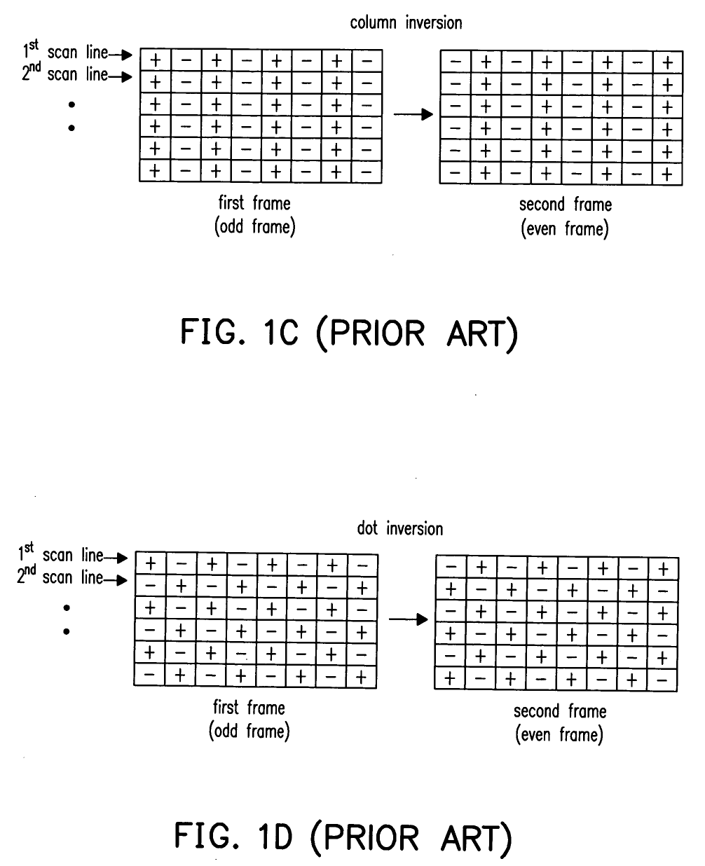

### DESCRIPTION OF THE EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

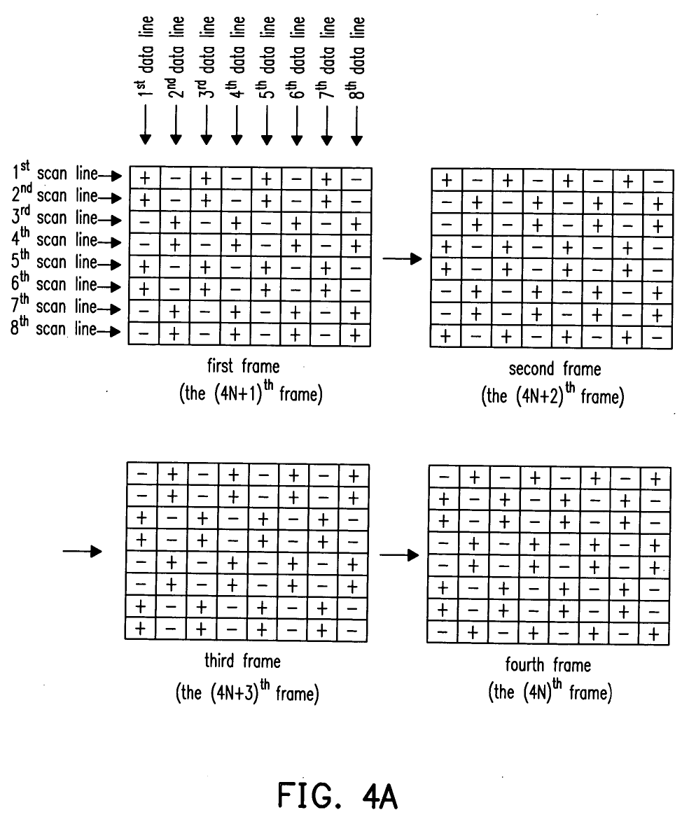

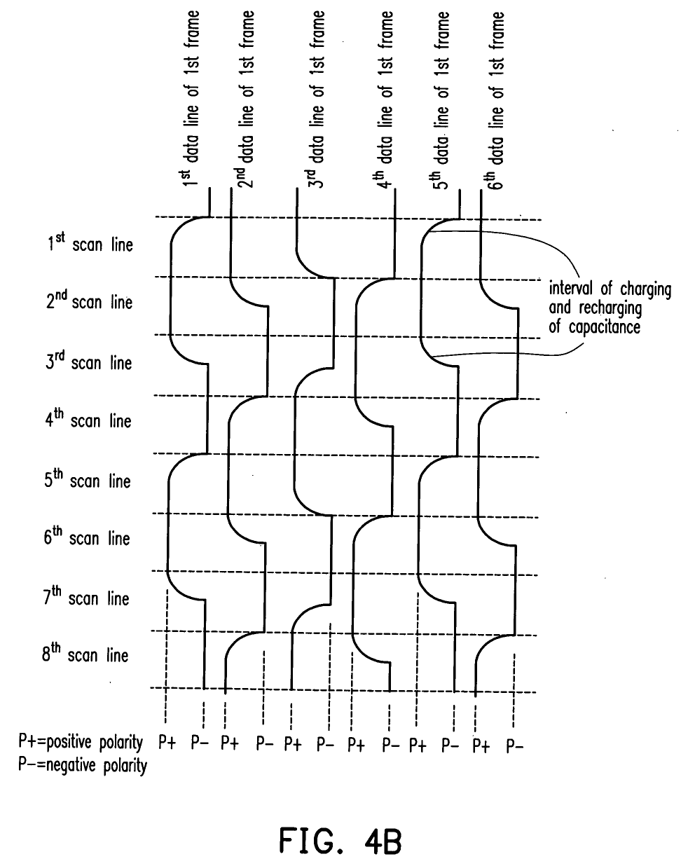

FIGS. 4A and 4B illustrate a polarity distribution and a scanning waveform of a two-line inversion method in accordance with one embodiment of the present invention. Referring to FIG. 4A, in the two-line inversion method according to one embodiment of the present invention, the polarity of the entire frame is repeated after the scanning of every four frames. However, in the conventional two-line inversion method, the polarity of the entire frame is repeated after the scanning of every two frames. In one embodiment of the invention, referring to FIG. 4A, for example but not limited to, the polarities of the first to the fourth scan lines of the first data line is changed from (+, +, −, −) in the first frame to (+, −, −, +) in the second frame, to (−, −, +, +) in the third frame and to (−, +, +, −) in the fourth frame. Thereafter, the polarities described above will return back to (+, +, −, −) in the fifth (4+1) frame.

Referring to FIG. 4B, for example, when the frame is changed sequentially from the first frame to the fourth frame, the charging state of the pixels at the intersection of the first data line and the first scan line comprises the state of charging, positively charged, discharging and negatively charged. Likewise, the charge state of the pixel at the intersection of the second scan line and the first data line from the first frame to the four frames comprises the states of positively charged, discharging, negatively charged and charging. Hence, for the first frame to the fourth frame, the average charge distribution (proportional to the average area of the waveform) of the pixel of the first scan line is the same as that of the second scan line. I.e., after every four consecutive frames, it is observed by the user that the average brightness of the pixel of the first scan line is the same as that of the second scan line due to the effect of persistence of vision. Likewise, for any of the first to the eighth scan lines shown in FIG. 4B, all of the charging states of four consecutive frames include the state of charging, positively charged, discharging and negatively charged. Hence, after every four consecutive frames, all of the pixels of the frame has a same average brightness. Especially, when the entire frame has the same color, has some fixed images displayed repeatedly, or has a fixed image (e.g., the background image), the present invention can effectively reduce the problem of alternate brightness.

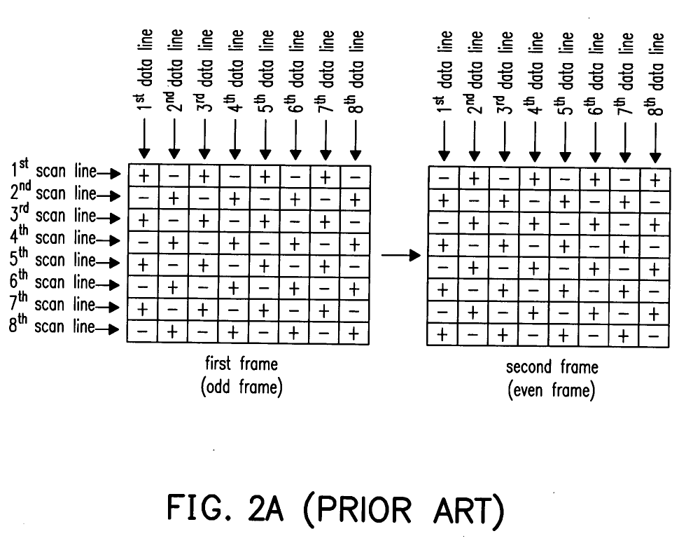

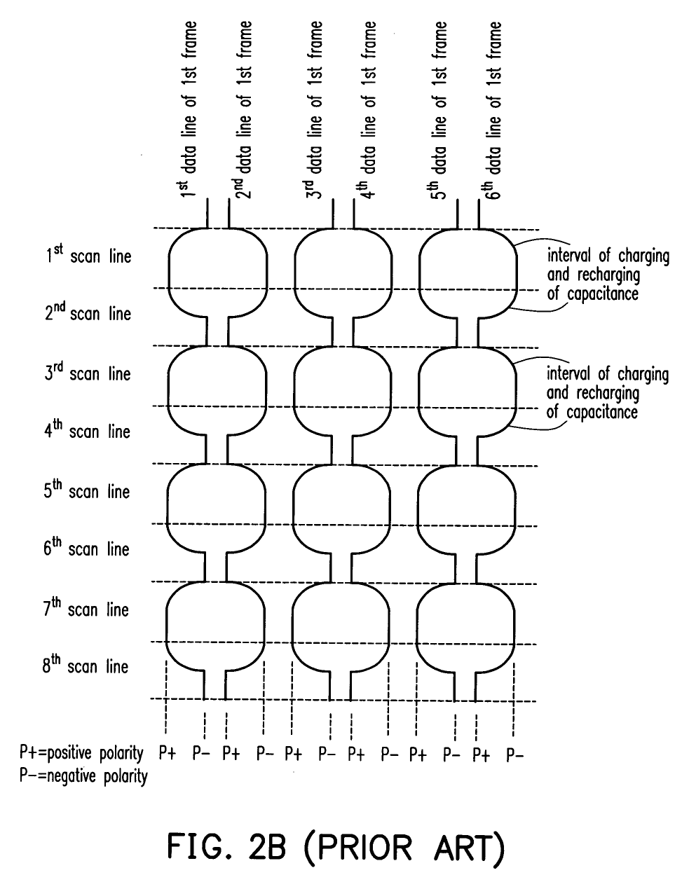

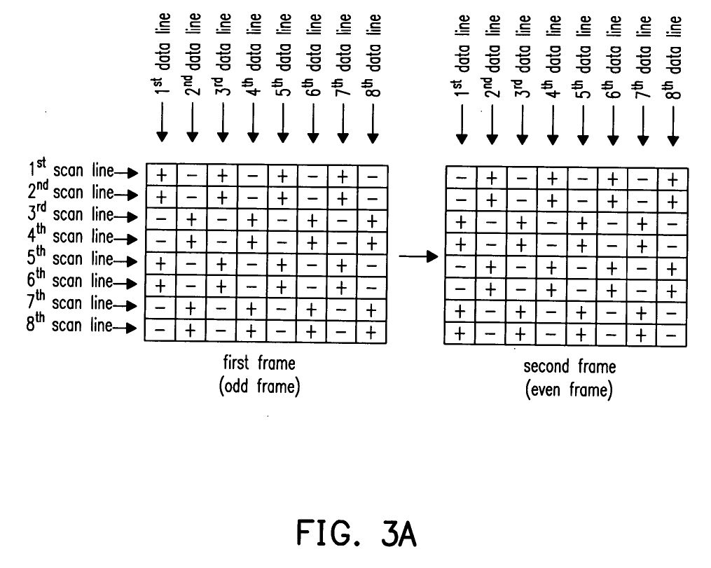

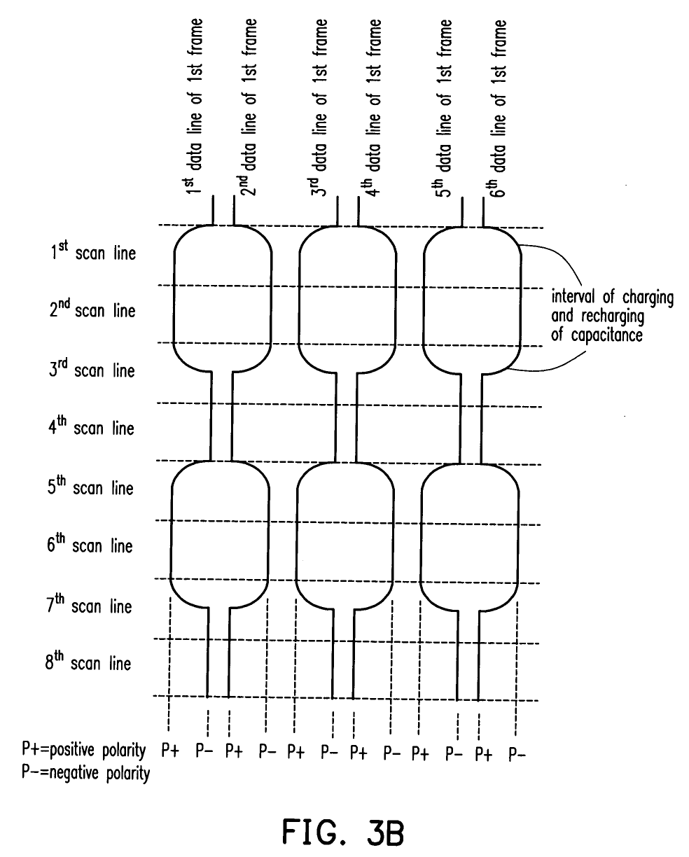

Referring to FIG. 4B, for the first data line in any frame or for any data line, the interval between charging the capacitor and discharging the capacitor is about twice as many as that of the conventional dot inversion method of FIG. 2B. Hence, in the present invention, a higher brightness is obtained by applying a lower current, therefore, the power consumption of the present invention is reduced.

In addition, referring to FIG. 4A, the polarity distribution on the LCD is, for example but not limited to, constructed by repeating a basic distribution such as (+, +. −, −) periodically. Hence, the polarities of two adjacent pixels or every other two pixels are opposite, and the polarities of the pixels in the entire frame are repeated every four frames. Therefore, the present invention can reduce the flicker and cross-talk problems.

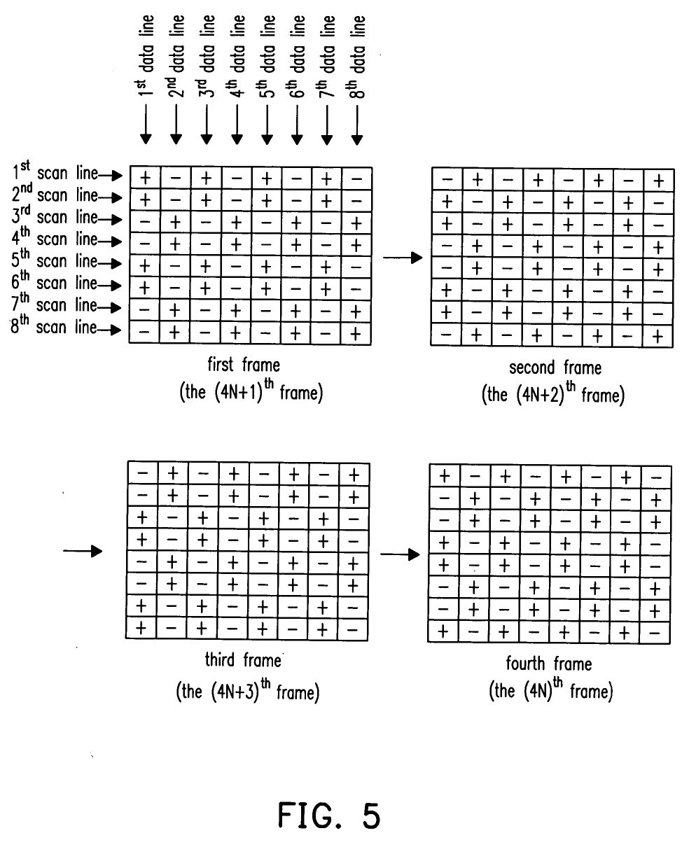

FIG. 5 illustrates the polarity distribution of the two-line inversion method in accordance with another embodiment of the present invention. Referring to FIG. 5, the difference between the present embodiment and the embodiment of FIG. 4A is that for the polarities of the first to the fourth scan lines of the first data line, the polarity of the first frame through the fourth frame is changed from (+, +, −, −) to (−, +, +, −) to (−, −, +, +) to (+, −, −, +), and go back to (+, +, −, −) in the fifth frame. It is noted that the polarity inversion proposed in FIG. 4A and FIG. 5 are provided as examples only and cannot used to limit the scope of the present invention.

Hence, according to the above embodiments, the present invention provides a method for driving a LCD. The LCD has a plurality of data lines. The polarity distributions of the adjacent data lines are different. The polarity distribution of each data line is a specific polarity distribution constructed by repeating any one of (+, +, −, −), (−, +, +, −), (−, −, +, +) and (+, −, −, +). The specific polarity distribution has four specific polarities, wherein two adjacent specific polarities have the first polarity (+ or −) and the other two specific polarities have the second polarity (− or +). In addition, the specific polarity distribution in a first, a second, a third and a fourth frame are a first, a second, a third and a fourth specific polarity distribution respectively. In one embodiment of the invention, the successive specific polarity distribution is obtained by shifting the forefront specific polarity of the prior specific polarity distribution to the last and the other specific polarities remain the same. For example, in FIG. 4A, the second frame has a second specific polarity distribution (+, −, −, +) and thus the third frame has a third specific polarity distribution (−, −, +, +). In another embodiment of the invention, the successive specific polarity distribution is obtained by shifting the last specific polarity of the prior specific polarity distribution to the forefront and the other specific polarities remain the same. For example, in FIG. 5, the third frame has a third specific polarity distribution (−, −, +, +) and thus the fourth frame has a fourth specific polarity distribution (+, −, −, +).

In addition, the present invention provides a method of driving a LCD. The LCD has a plurality of data lines. Each of the data lines has a plurality of pixels and each pixel has a capacitor. The method of the invention provides each capacitor for a charging state as shown in FIG. 4B. All the capacitors of the pixels in each data line (e.g., the first data line of FIG. 4B) have a data line charge distribution. As shown in FIG. 4A, the data line charge distributions of two adjacent data lines are different. The charge distribution of each data line is constructed by repeating a specific charge distribution. The specific charge distribution has four specific charging states including the state of positively charged, discharging, negatively charged, and charging as shown in the second scan line to the fifth scan line of the first frame of the FIG. 4B. The specific charge distribution of a first, a second, a third and a fourth frame are a first, a second, a third and a fourth specific charge distribution respectively. In one embodiment of the invention, referring to FIG. 4B, the successive specific charge distribution is obtained by shifting the forefront specific charging state of the prior specific charge distribution to the last and the other specific charging states remain the same. In another embodiment of the invention, the successive specific charge distribution is obtained by shifting the last specific charging state of the prior specific charge distribution to the forefront and the other specific charging states remain the same. In addition, it is noted that one of four consecutive frames (e.g., one of the first frame to the fourth frame shown in FIG. 4B) has the specific charge distribution arranged in an order of the state of charging, positively charged, discharging and negatively charged (e.g., the first frame).

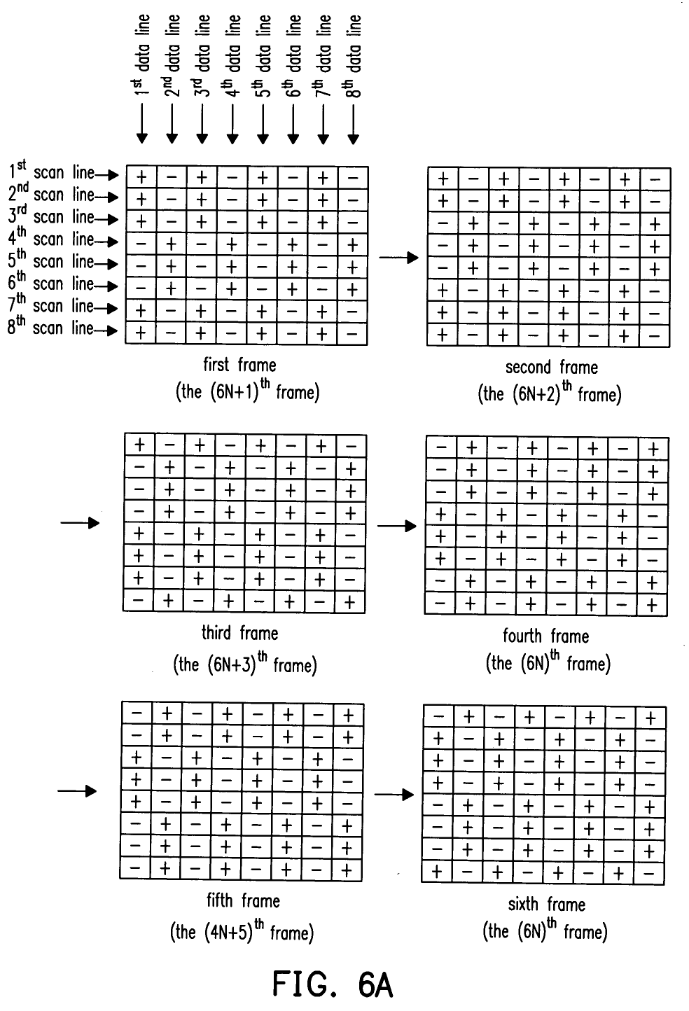

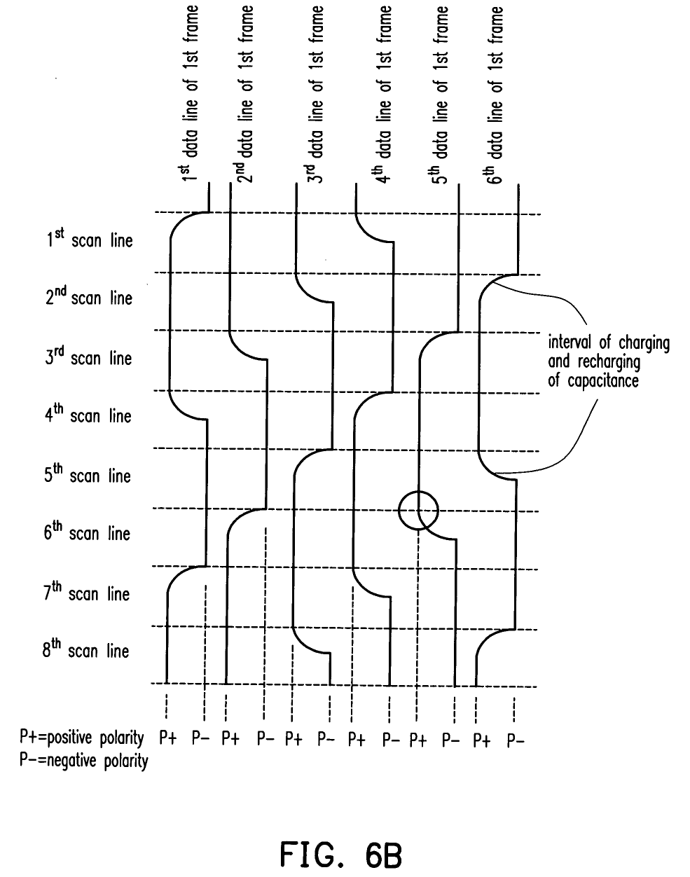

FIG. 6A and FIG. 6B illustrate the polarity distribution of the three-line inversion method in accordance with one embodiment of the present invention. In comparison with the embodiments of the two-line inversion method described above, the polarity of the frames of the present embodiment shown in FIG. 6A and FIG. 6B are repeated every six frames. For example, the polarities of the first to the sixth scan lines of the first data line in each frame is inverted from (+, +, +, −, −, −) to (+, +, −, −, −, +) to (+, −, −, −, +, +) to (−, −, −, +, +, +) to (−, −, +, +, +, −) to (−, +, +, +, −, −) and go back to (+, +, +, −, −, −) in the seventh frame.

Referring to FIG. 6B, for any one of the first to the eighth scan lines of the first data line, all the charge distributions in 6 consecutive frames include 6 states of positively charged, positively charged, discharging, negatively charged, negatively charged and charging. In other words, after 6 consecutive frames, all the pixels of the frame have the same average brightness. Therefore, the present invention can effectively reduce the problem of alternate brightness.

In another embodiment of the present invention, the polarities of the first to the sixth scan lines of the first data line in each frame is inverted from (+, +, +, −, −, −) to (−, +, +, +, −, −) to (−, −, +, +, +, −) to (−, −, −, +, +, +) to (+, −, −, −, +, +) to (+, +, −, −, −, +) and go back to (+, +, +, −, −, −) in the seventh frame. Likewise, it should be noted that the polarity inversion proposed in FIG. 6A is only provided as an, example and cannot used to limit the scope of the present invention.

Referring to FIG. 6B, for any of the first scan line to the eighth scan line, e.g., the first scan line, in six consecutive frames (e.g., the first to the sixth frame), only the second frame and the third frame remain at the positive polarity state and the fifth frame and the sixth frame remain at the negative polarity state. Therefore, the characteristics of the liquid crystal molecule will not be damaged. In addition, the interval between charging the capacitor and discharging the capacitor of the three-line inversion method of FIG. 6B is about 1.5 times as many as that of the two-line inversion method of FIG. 4B. Hence, in the present invention, a higher brightness is obtained by applying a lower current, therefore, the power consumption of the present invention is reduced.

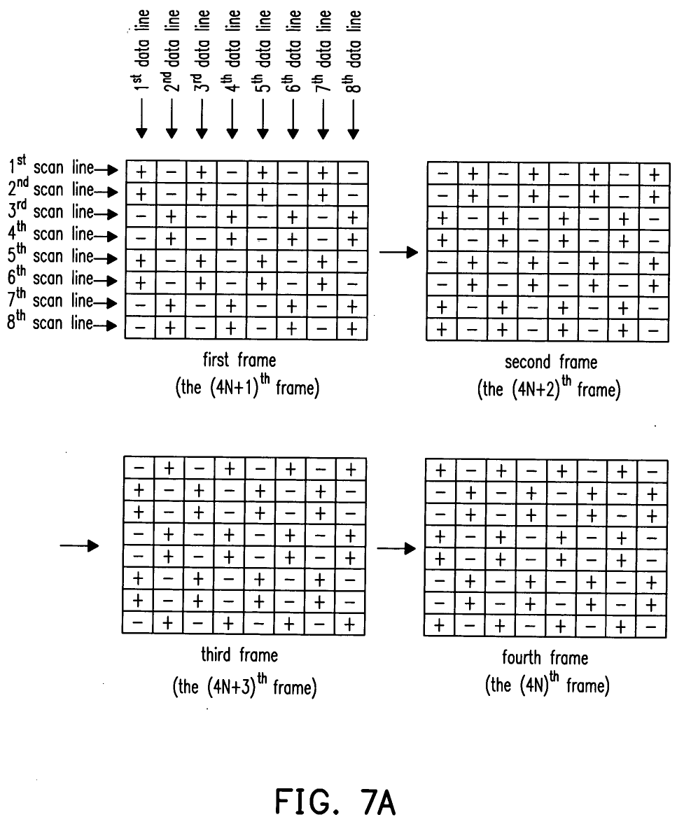

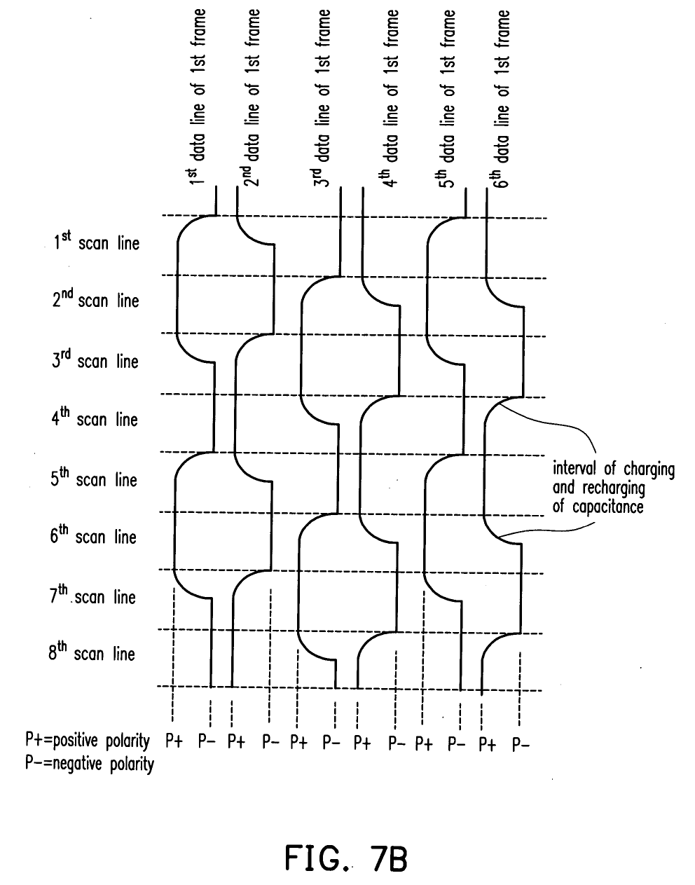

FIG. 7A and FIG. 7B illustrate the polarity distribution of the three-line inversion method in accordance with one embodiment of the present invention. Referring to FIG. 4A, the polarities of the first to the fourth scan lines of the first data line in each frame is inverted from (+, +, −, −) to (+, −, −, +) to (−, −, +, +) to (−, +, +, −) and go back to (+, +, −, −) in the fifth frame. However, referring to FIG. 7A, the polarities of the first to the fourth scan lines of the first data line in each frame is inverted from (+, +, −, −) to (−, −, +, +) to (−, +, +, −) to (+, −, −, +) and go back to (+, +, −, −) in the fifth frame. In other words, the arrangement of the polarity inversion of the first frame to the fourth frame in FIG. 4A is re-arranged to obtain the arrangement of the polarity inversion of the first frame to the fourth frame in FIG. 7A. Hence, the scope of the present invention also includes the re-arrangement of the polarity inversion of the first frame to the fourth frame in FIG. 4A or the polarity inversion of the first frame to the sixth frame in FIG. 6A. For example, in FIG. 4A, there are four frames with different polarity distributions, therefore, there are 4*3*2*1=24 arrangements for the four frames. However, since each polarity inversion (e.g., referring to FIG. 4A) can be started from any one of the four frames (e.g., started from (−, −, +, +) to (−, +, +, −) to (+, +, −, −) to (+, −, −, +) and go back to (−, −, +, +)), thus there are 24/4=6 different ways to implement the polarity inversion for the four frames shown in FIG. 4A. The polarity inversion shown in FIG. 4A and FIG. 7A are two ways of them.

Referring to FIG. 7A, during the first frame to the fourth frame, it is noted that the polarity distribution of any the pixels have two positive polarity (+) and two negative polarity (−). For example, the polarities of the pixel at the intersection of the first scan line and the first data line in the four frames are +, −, −, and +. In addition, the polarities of the pixel at the intersection of the second scan line and the first data line in the four frames are +, −, +, and −. Hence, during any four consecutive frames, there two positive polarities (e.g., the first polarity) and two negative polarities (e.g., the negative polarity) for any pixel of the frame.

Referring to FIG. 7B, from the first frame to the fourth frame, it is noted that the charging state of the pixel at the intersection of the first scan line and the first data line has the states of charging, discharging, negatively charged, and positively charged. The charging states of the pixel at the intersection of the second scan line and the first data line in the four frames has the states of positively charged, negatively charged, charging, and discharging. Hence, from the first frame to the fourth frame, the average charge distribution (i.e., the average of the area of the waveform) of the pixel in the first scan line is the same as that of the pixel in the second scan line. In other words, after every four consecutive frames, the average brightness of any pixel of the frame is the same.

Accordingly, in the method of polarity inversion of the LCD of the present invention, the interval between charging of the capacitor and discharging of the capacitor is large than that of the conventional dot inversion method. Therefore, in the present invention, a higher brightness is obtained by applying a lower current in comparison with the conventional method. Thus the power consumption of the present invention is reduced. In addition, after every four, six or more consecutive frames, it is observed all of the pixels of the frame have the same average brightness due to the persistence of vision. Especially, when the entire frame has the same color, has some fixed images displayed repeatedly, or has a fixed image (e.g., the background image), the present invention can effectively reduce the problem of alternate brightness.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for driving a liquid crystal display, wherein liquid crystal display has a plurality of data lines, each of the data line corresponds to a plurality of pixels, the method comprising:
using a plurality of specific polarity distributions to drive the pixels of each of the data line, wherein a first frame has a first specific polarity distribution, a successive second frame after the first frame has a second specific polarity distribution, a third frame after the second frame has a third specific polarity distribution, and a fourth frame after the third frame has a fourth specific polarity distribution, wherein the first, the second, the third and the fourth specific polarity distributions are different from each other.

2. The method of claim 1, wherein each of the specific polarity distribution has four specific polarities, two of the four specific polarities have a first polarity, and the other two of the four specific polarities have a second polarity.

3. The method of claim 1, wherein the first, the second, the third, and the fourth specific polarity distributions are arrange by a polarity circulation rule such that the first, the second, the third, and the fourth specific polarity distributions are different from each other.

4. The method of claim 3, wherein in the polarity circulation rule, a successive specific polarity distribution is constructed by shifting a forefront specific polarity of the specific polarities of a prior specific polarity distribution to the last and the other specific polarities are remained the same.

5. The method of claim 3, wherein in the polarity circulation rule, a successive specific polarity distribution is constructed by shifting a last specific polarity of the specific polarities of a prior specific polarity distribution to the forefront and the other specific polarities remain the same.

6. The method of claim 2, wherein in each of the four specific polarities, the two of the four specific polarities having the first polarity are adjacent to each other, and/or the other two of the four specific polarities having a second polarity are adjacent to each other.

7. A method for driving a liquid crystal display, wherein the liquid crystal display has a plurality of data lines, each the data line correspond to a plurality of pixels, and each of the pixels has a capacitor, the method comprising:
using a plurality of specific charge distributions to drive the pixels of each of the data lines, wherein a first frame has a first specific charge distribution, a successive frame after the first frame has a second specific charge distribution, a third frame after the second frame has a third specific charge distribution, and a fourth frame after the third frame has a fourth specific charge distribution, wherein the first, the second, the third, and the fourth specific charge distributions are different from each other.

8. The method of claim 7, wherein each of the first, the second, the third, and the fourth specific charge distributions comprises four specific charging states comprising a charging state, a positively charged state, a discharging state and a negatively charged states.

9. The method of claim 7, wherein the first, the second, the third, and the fourth specific charge distributions are arrange by a charging state circulation rule such that the first, the second, the third, and the fourth specific charge distributions are different from each other.

10. The method of claim 9, wherein in the charging state cycle, a successive specific charge distribution is constructed by shifting a forefront specific charging state of a prior specific charge distribution to the last and the other specific charging state remain the same.

11. The method of claim 9, wherein in the charging state cycle, a successive specific charge distribution is constructed by shifting a last specific charging state of a prior specific charge distribution to the forefront and the other specific charging state remain the same.

12. A method for driving a liquid crystal display, wherein liquid crystal display has a plurality of data lines, each of the data line correspond to a plurality of pixels, the method comprising:
using a plurality of specific polarity distributions to drive the pixels of each of the data line, wherein a first frame has a first specific polarity distribution, a successive second frame after the first frame has a second specific polarity distribution, and thus from the first frame to a 2n^{th} (n>2) frame has the first specific polarity distribution and a 2n specific polarity distribution respectively, wherein from the first to the 2n^{th} specific polarity distributions are different from each other.

13. The method of claim 12, wherein each of the 2n specific polarity distributions has 2n specific polarities, n of the 2n specific polarities have a first polarity, and the other n of the 2n specific polarities have a second polarity.

14. The method of claim 13, wherein the first, the second, the third, and the fourth specific polarity distributions are arrange by a polarity circulation rule such that the first, the second, the third, and the fourth specific polarity distributions are different from each other.

15. The method of claim 14, wherein in the polarity circulation rule, a successive specific polarity distribution is constructed by shifting a forefront specific polarity of the specific polarities of a prior specific polarity distribution to the last and the other specific polarities remain the same.

16. The method of claim 14, wherein in the polarity circulation rule, a successive specific polarity distribution is constructed by shifting a last specific polarity of the specific polarities of a prior specific polarity distribution to the forefront and the other specific polarities remain the same.

17. The method of claim 13, wherein in each of the 2n specific polarities, the n of the four specific polarities having the first polarity are adjacent to each other, and/or the other n of the four specific polarities having a second polarity are adjacent to each other.

18. A method for driving a liquid crystal display, wherein the liquid crystal display has a plurality of data lines, each the data line is corresponding to a plurality of pixels, and each of the pixels has a capacitor, the method comprising:
using a plurality of specific charge distributions to drive the pixels of each of the data lines, wherein a first frame has a first specific charge distribution, a successive frame after the first frame has a second specific charge distribution, an thus from the first fame to a 2n^{th} frame has the first specific charge distribution and a 2n^{th} specific charge distribution, wherein from the first to the 2n^{th} specific charge distributions are different from each other.

19. The method of claim 18, wherein each of the first to the 2n^{th} specific charge distributions comprises 2n specific charging states comprising a charging state, n−1 positively charged state, a discharging state and n−1 negatively charged states.

20. The method of claim 18, wherein each of the first to the 2n^{th} specific charge distributions are arrange by a charging state circulation rule such that the first to the 2n^{th} specific charge distributions are different from each other.

21. The method of claim 20, wherein in the polarity circulation rule, a successive specific polarity distribution is constructed by shifting a forefront specific polarity of the specific polarities of a prior specific polarity distribution to the last and the other specific polarities remain the same.

22. The method of claim 20, wherein in the charging state cycle, a successive specific charge distribution is constructed by shifting a last specific charging state of a prior specific charge distribution to the forefront and the other specific charging state remain the same.

23. The method of claim 18, wherein in each of the first to the 2n^{th} specific charge distributions, the n−1 positively charged statuses are adjacent to each other, and/or the n−1 negatively charged statuses are adjacent to each other.
